(19) United States
(12) Patent Application Publication
(10) Pub. No.: US 2006/0077042 A1
(43) Pub. Date: Apr. 13, 2006

(54) Method for avoiding an unauthorized access to passive access-authorization system of a motor vehicle

(76) Inventor: Alexander Hock, Leonberg (DE)

Correspondence Address: KENYON & KENYON LLP, ONE BROADWAY, NEW YORK, NY, 10004, US

(21) Appl. No.: 11/240,223

(22) Filed: Sep. 29, 2005

(30) Foreign Application Priority Data
Sep. 29, 2004 (DE) 102004047187.8

(51) Int. Cl. H04Q 5/22; B60L 1/00

(52) U.S. Cl. 340/10.4; 307/10.1

(57) ABSTRACT

A method for avoiding an unauthorized access to a passive access-authorization system of a motor vehicle having a vehicle-side transceiver and a portable transponder. In case of a query signal having a first radio reach, transmitted from the transceiver to the transponder, a second radio reach of a response signal transmitted by the transponder to the vehicle-side transceiver, is reduced.

### BACKGROUND INFORMATION

Described in German Patent Application No. DE 102 55 880 is a passive access-authorization system (Comfort/Entry Go—CEG) having a base station and a transponder for a motor vehicle, as well as a method for detecting and/or repelling an external attack on the CEG system, for instance a radio link extension caused by a relay attack. For this purpose at least one first or second time-delay element for adjusting a defined, in particular essentially constant signal propagation time is arranged in the base station and/or the transponder.

Described in German Patent No. DE 44 09 167 is a device for controlling a keyless access to a motor vehicle having a distance-detection device which measures the distance between a transponder and a motor vehicle. The device additionally includes a transmitter which is located in the transponder and emits an answer code signal in response to a query code signal transmitted by a transmitter arranged in the vehicle only if the motor vehicle is located in the immediate vicinity of the transponder.

### SUMMARY OF THE INVENTION

The method according to the present invention has the advantage over the related art that an unauthorized access to a passive access-authorization system of a motor vehicle having a vehicle-side transceiver and a transponder, for instance by increasing a first radio reach with the aid of an interconnected attack means, is able to be avoided even if the motor vehicle is located within an area around the transponder that has been provided for a second radio reach to establish a radio link between the transponder and the motor vehicle. To this end, in the case of a query signal that has a first radio reach and has been transmitted by the transceiver, the second radio reach of a response signal emitted by the transponder to the vehicle-side transceiver will be reduced. Furthermore, the method according to the present invention provides the advantage of a very cost-effective and simple realization since, for instance, it does not require a costly distance-detection device in the vehicle and/or in the transponder.

The second radio reach is able to be reduced in an advantageous manner by lowering the transmission power of the transponder. However, in an alternative embodiment, it is also possible to detune a receiving antenna of a vehicle-side transceiver and/or to increase a threshold value of the reception field strength of the vehicle-side transceiver. If a radio reach limiter, is already integrated in the transponder, for instance for comfort functions such as the opening and closing of windows or the like, it also may be utilized to reduce the second radio reach.

Another aspect of the method according to the present invention provides that the first radio reach relates to a low-frequency signal transmitted by the transceiver of the motor vehicle, and the second radio reach relates to a high-frequency signal transmitted by the transponder. This allows the first radio reach of a query signal transmitted as low-frequency signal in the kHZ range to be considerably lower than the second radio reach of a response signal transmitted as high-frequency signal in the MHz or GHz range. This provides higher security against attacks by unauthorized persons inasmuch as the query signal for initiating an opening or closing procedure of the vehicle doors is able to be received by the transponder only in the immediate vicinity of the motor vehicle, for instance within a radius of maximally one to three meters, so that the opening or closing procedure of the vehicle doors initiated by the high-frequency response signal is directly noticeable by the authorized user. In contrast to the low-frequency query signal, the high-frequency response signal has a considerably greater radio reach of more than 15 meters so as to be able to actively open or close the vehicle even from a greater distance, i.e., by means of an operating element, that is to say, without a received query signal being required. In this connection, it is especially advantageous if the second radio reach of the response signal is reduced to approximately the first radio reach of the query signal.

### BRIEF DESCRIPTION OF THE DRAWING

FIG. 1 shows a schematic representation of an exemplary embodiment of the method according to the present invention.

### DETAILED DESCRIPTION

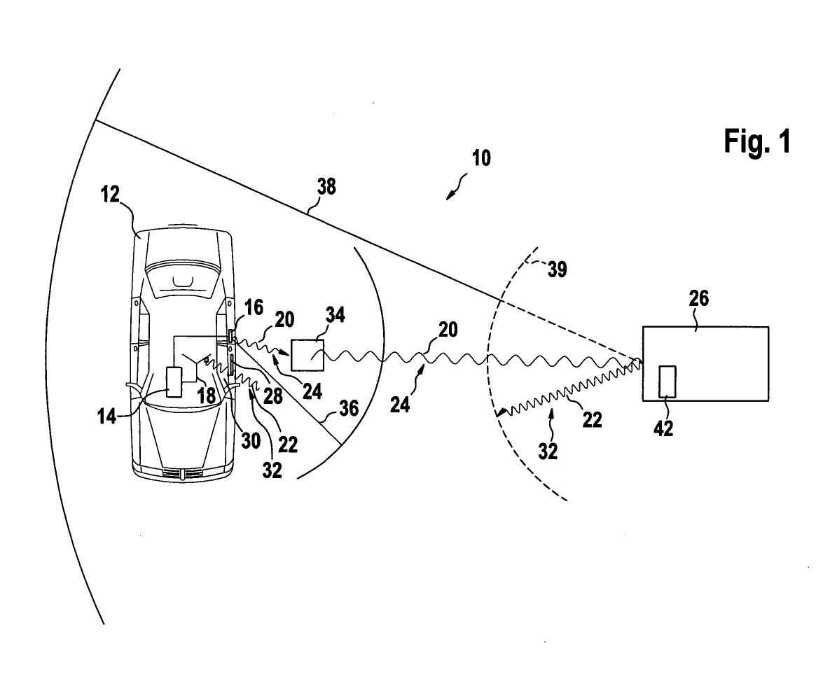

FIG. 1 shows a schematic representation of an exemplary embodiment of the method according to the present invention for avoiding an unauthorized access to a passive access-authorization system 10 of a motor vehicle 12. Passive access-authorization system 10 includes, among others, a vehicle-side transceiver 14, which is connected to a transmission antenna 16 and a receiving antenna 18. Transmission antenna 16 is preferably suitable for sending a low-frequency signal 20, whereas a high-frequency signal 22 may be received with the aid of receiving antenna 18.

For the proper operation (not shown in FIG. 1) of passive access-authorization system 10 according to the related art, transmission antenna 16 transmits low-frequency signal 20 as a generally encoded and encrypted query signal 24 (challenge) to a portable transponder 26, query signal 24 being triggered by, for instance, the activation of a door handle 28 of a vehicle door 30 of motor vehicle 12. In response, high-frequency signal 22 is generated in transponder 26 and transmitted back to motor vehicle 12 as a normally also encoded and encrypted response signal 32 (response). If response signal 32 matches a reference signal stored in a vehicle-side memory of passive access-authorization system 10, vehicle door 30 will be opened or closed according to query signal 24.

If an attack on passive access-authorization system 10 then occurs with the aid of an attack means 34 that enlarges a first radio reach 36 between transponder 26 and motor vehicle 12 by receiving low-frequency signal 20 originally restricted to first radio reach 36 after door handle 28 has been activated to open vehicle door 30 and forwarding it to transponder 26 as query signal 24, transponder 26 in turn transmits response signal 32 as high-frequency signal 22. While first radio reach 36 of low-frequency signal 20 amounts to maximally one to three meters, a second radio reach 38 of high-frequency signal 22, amounting to more than 15 meters, is clearly greater for the aforementioned reasons.

If motor vehicle 12 is located within second radio reach 38, response signal 32 transmitted as high-frequency signal 22 is received by receiving antenna 18 and forwarded to transceiver 14 of vehicle 12 for comparison with the reference signal stored there. In case of a match, vehicle door 30 will therefore be opened although this was by no means intended by the user of motor vehicle 12. An unauthorized person thus obtains access to motor vehicle 12 and is able to steal it by a starting procedure initiated in the same manner.

In order to avoid this unauthorized access to passive access system 10 of motor vehicle 12, the method of the present invention according to FIG. 1 provides that second radio reach 38 of response signal 32 transmitted by transponder 26 to vehicle-side transceiver 14 is reduced to range 39 indicated by the dashed line, so that second radio reach 38 corresponds approximately to first radio reach 36 (indicated by dashed region 39). However, as an alternative, second radio reach 38 may also be reduced by a small amount. As the case may be, the reduction of second radio reach 38 must occur in such a way that response signal 32 transmitted by transponder 26 as high-frequency signal 22 is no longer able to be received by transceiver 14 of motor vehicle 12, so that no reaction occurs following the unauthorized access to open or start motor vehicle 12.

According to the present invention, second radio reach 38 is reduced by lowering the transmission power of transponder 26. If transponder 26 already encompasses an integrated radio-range limiter 42 to activate or deactivate comfort functions such as the opening or closing of windows, the sunroof or the like, it may be utilized to reduce second radio reach 38. As an alternative or in addition, it is also possible to reduce second radio reach 38 by detuning vehicle-side receiving antenna 18 and/or by increasing a threshold value of the reception field strength of vehicle-side transceiver 14. Although the receiving-side measures do not cause a direct reduction of second radio reach 38, their effect may certainly be equated thereto.

A so-called relay station is generally used as attack means 34 shown in FIG. 1. An unauthorized access to passive access-authorization system 10 illustrated here is therefore also referred to as a relay attack.

Finally, it should be pointed out that the exemplary embodiment shown is not limited either to FIG. 1 or the mentioned values for first and second radio reach 36 and 38 or to the number of interconnected attack means. In the same way the method according to the present invention may be used for passive access-authorization systems that utilize identical carrier frequencies, i.e., either in the low-frequency kHz range or in the high-frequency MHz or GHz range, both for query signal 24 and for response signal 32. Furthermore, the method according to the present invention also may be utilized for passive access-authorization systems that already include a vehicle-side and/or transponder-side distance-detection device. Finally it should be mentioned that the term passive access-authorization system also relates to the passive portion of a keyless access-authorization system, in particular a so-called Comfort/Entry-Go System (CEG), i.e., a system that allows both access and starting of a motor vehicle in a keyless manner.

What is claimed is:

1. A method for avoiding an unauthorized access to a passive access-authorization system of a motor vehicle having a vehicle-side transceiver and a portable transponder, the method comprising:
in case of a query signal having a first radio reach, transmitted from the transceiver to the transponder, reducing a second radio reach of a response signal transmitted by the transponder to the transceiver.

2. The method according to claim 1, wherein the second radio reach is reduced by lowering a transmission power of the transponder.

3. The method according to claim 1, wherein the second radio reach is reduced by at least one of (a) detuning a receiving antenna and (b) increasing a threshold value of a reception field strength of the vehicle-side transceiver.

4. The method according to claim 1, wherein the second radio reach is reduced by a radio-range limiter integrated in the transponder.

5. The method according to claim 1, wherein the first radio reach relates to a low-frequency signal transmitted from the transceiver of the motor vehicle, and the second radio reach relates to a high-frequency signal transmitted by the transponder.

6. The method according to claim 1, wherein the second radio reach is reduced to about the first radio reach.
